(19) United States
(12) Patent Application Publication
(10) Pub. No.: US 2007/0189416 A1
(43) Pub. Date: Aug. 16, 2007

(54) Apparatus and method for Orthogonal Spatial Multiplexing in a closed-loop MIMO-OFDM system

(75) Inventors: Young-Soo Kim, Seoul (KR); Dong-Jun Lee, Seoul (KR); Jung-Hoon SUH, Yongin-si (KR); Kyung-Hun Jang, Suwon-si (KR); Hyo-Sun Hwang, Seoul (KR); In-Kyu Lee, Seoul (KR); Heun-Chul Lee, Pocheon-si (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Korea University Industry and Academy Cooperation Foundation, Seoul (KR)

(21) Appl. No.: 11/655,780

(22) Filed: Jan. 19, 2007

(30) Foreign Application Priority Data
Jan. 19, 2006 (KR) 10-2006-0005759

(51) Int. Cl. H04L 27/00; H04L 1/02

(52) U.S. Cl. 375/299; 375/267; 375/347

(57) ABSTRACT

An Orthogonal Spatial Multiplexing (OSM) apparatus and method in a closed-loop Multiple Input Multiple Output-Orthogonal Frequency Division Multiplexing (MIMO-OFDM) system are provided. In the OSM method, a basic signal model is set and transmission symbols are encoded. A real-valued system model corresponding to the basic signal model is obtained. To achieve orthogonality, rotations angles are calculated and are applied to the encoded transmission symbols.

### PRIORITY

This application claims priority under 35 U.S.C. §119 to a Korean application filed in the Korean Intellectual Property Office on Jan. 19, 2006 and assigned Serial No. 2006-5759, the contents of which are incorporated herein by reference.

### BACKGROUND OF THE INVENTION

1. Field of the Invention

The present invention relates to an apparatus and method for Orthogonal Spatial Multiplexing (OSM) in a closed-loop Multiple Input Multiple Output-Orthogonal Frequency Division Multiplexing (MIMO-OFDM) system.

2. Description of the Related Art

Provisioning of services with diverse Quality of Service (QoS) levels at about 100 Mbps to users is an active study area in a future-generation communication system called a 4^{th} Generation (4G) communication system.

In particular, active research is being conducted on provisioning of high-speed service by ensuring mobility and QoS to a Broadband Wireless Access (BWA) communication system, such as Wireless Local Area Network (WLAN) and Wireless Metropolitan Area Network (WMAN). An Institute of Electrical and Electronics Engineers (IEEE) 802.16 communication system is an example of such a communication system.

An IEEE 802.16 communication system is implemented by applying OFDM/Orthogonal Frequency Division Multiple Access (OFDMA) to physical channels of a WMAN system to support a broadband transmission network.

In MIMO-OFDM technology, a two-antenna system is considered most prominent for practical implementation.

When Channel State Information (CSI) is known to a transmitter, a MIMO-OFDM system can improve system performance by optimizing a transmission scheme according to the current channel condition.

Studies on closed-loop MIMO channels have been focused on beamforming. Beamforming is carried out mathematically by Singular Value Deposition (SVD) of a channel transfer matrix. However, feedback information sent from a receiver to a transmitter should be kept as small as possible for beamforming. SVD should also be carried out with less complexity in computing eigenvalues and eigenvectors for beamforming.

To solve these problems, there exists a need for developing a novel spatial multiplexing scheme that reduces both computation complexity and an amount of feedback information, while yielding performance comparable to Singular Value Decomposition-BeamForming (SVD-BF) or a Maximum Likelihood (ML) technique.

### SUMMARY OF THE INVENTION

An object of the present invention is to substantially solve at least the above problems and/or disadvantages and to provide at least the advantages below. Accordingly, an object of the present invention is to provide an OSM apparatus and method in a closed-loop MIMO-OFDM system.

The above object is achieved by providing a method in a closed-loop MIMO-OFDM. In the OSM method, a basic signal model is set and transmission symbols are encoded. A real-valued system model corresponding to the basic signal model is obtained. To achieve orthogonality, rotations angles are calculated and are applied to the encoded transmission symbols.

The above object is achieved by providing an OSM apparatus in a closed-loop MIMO-OFDM. In the OSM apparatus, the apparatus includes a Forward Error Correction (FEC) encoder for adding a predetermined number of bits to transmission data, for error detection and correction, an interleaver for interleaving encoded data to prevent burst errors, a serial-to-parallel converter for parallelizing the interleaved data, a modulator for digitally modulating parallel data received from the serial-to-parallel converter, a linear pre-coder for pre-coding modulated data received from the modulator based on channel state information, and an Inverse Fast Fourier Transform (IFFT) processor for converting pre-coded data received from the pre-coder to time-domain sample data by IFFT.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter according to the present invention;

FIG. 2 is a block diagram of a receiver according to the present invention;

FIG. 3 is a flowchart illustrating a phase feedback-based OSM operation according to a phase feedback according to the present invention; and

FIG. 4 is a graph comparing SVD-BF with the OSM of the present invention in terms of Frame Error Rate (FER) performance.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an Orthogonal Spatial Multiplexing (OSM) apparatus and method in a closed-loop Multiple Input Multiple Output-Orthogonal Frequency Division Multiplexing (MIMO-OFDM) system.

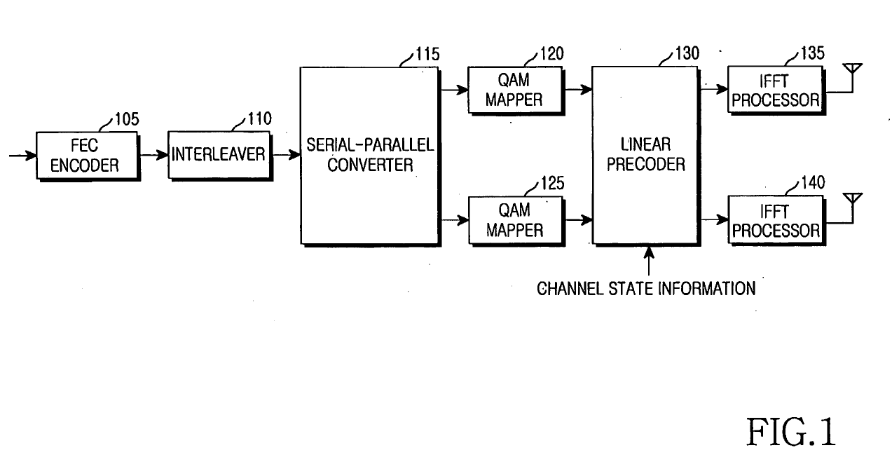

FIG. 1 shows a transmitter according to the present invention. A Forward Error Correction (FEC) encoder 105 adds a small number of bits to transmission data, for error detection and correction. The resulting FEC code functions to correct errors that may be produced as Signal-to-Noise Ratio (SNR) decreases with distance.

An interleaver 110 interleaves the data received from the FEC encoder 105 to prevent burst errors. A Serial-to-Parallel (S/P) converter 115 parallelizes the interleaved serial data.

Quadrature Amplitude Modulation (QAM) mappers 120 and 125 modulate the parallel data from the S/P converter 115. While QAM is shown in FIG. 1, any other modulation scheme may be used. The two QAM mappers 120 and 125 are used on the assumption of two transmit antennas. For the same reason, two other identical devices may exist, as described below.

A linear pre-coder 130 pre-codes the modulation symbols based on Channel State Information (CSI). The CSI is a rotation angle value which is feedback from a receiver. The computation of the rotation angle in the receiver will be described below. The transmission precoding involves encoding of the transmission signal using Equations (3) and (4) shown below.

Inverse Fast Fourier Transform (IFFT) processors 135 and 140 convert the pre-coded data to time-domain sample data by IFFT.

While not shown, the IFFT signals are subject to digital-to-analog conversion and upconversion to Radio Frequency (RF) signals, prior to transmission through the antennas.

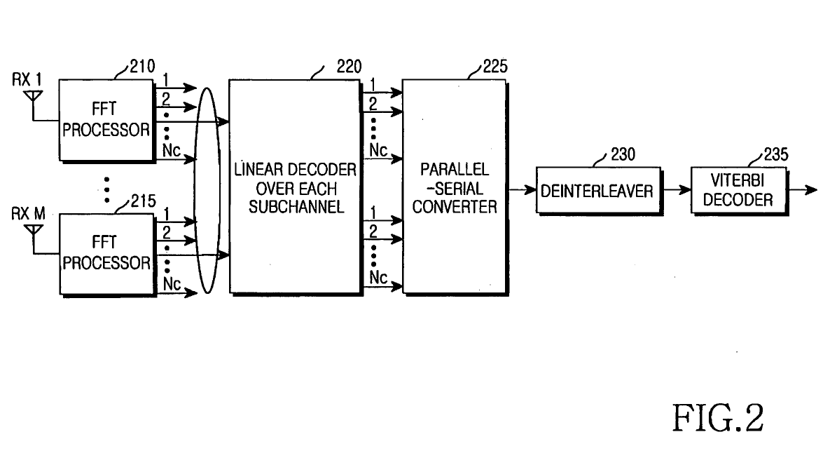

FIG. 2 shows a receiver according to the present invention. Fast Fourier Transform (FFT) processors 210 and 215 convert input time-domain sample data to frequency-domain data by FFT.

While not shown, signals received through antennas are subject to downconversion in an RF processor and analog-to-digital conversion, and then provided to the FFT processors 210 and 215.

A linear decoder 220 decodes the frequency data on a subchannel-by-subchannel basis based on CSI. The CSI is the rotation angle value. The CSI computation block (not shown) computes the rotation angle. The detailed computation will be described hereunder. The performance of the present invention is as much as that of Maximum Likelihood (ML) estimation. A Parallel-to-Serial (P/S) converter 25 serializes the parallel decoded data.

A deinterleaver 230 deinterleaves the serial data to prevent burst errors. A Viterbi decoder 235 decodes the convolution code of the deinterleaved data.

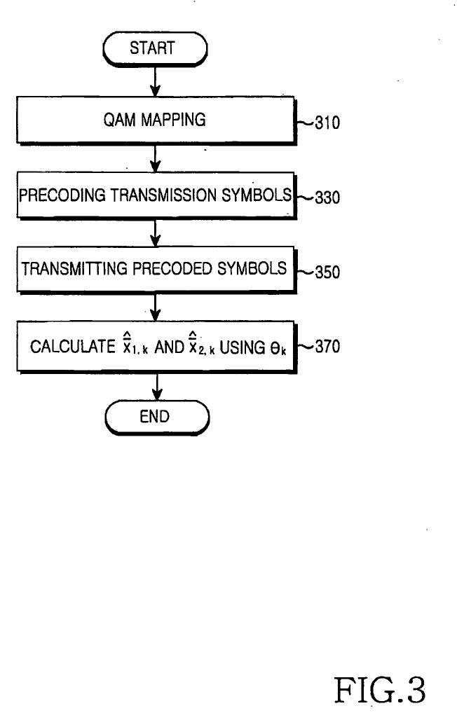

FIG. 3 shows a phase feedback-based OSM operation according to a phase (rotation angle) feedback from the receiver according to the present invention. The present invention is described in the context of a spatial multiplexing system with two transmit antennas and M (≧2) receive antennas.

A basic signal model between the transmitter and the receiver is as follows. Let a two-dimensional complex transmitted signal be denoted by x̅ₖ at a k^{th} subchannel and an M-dimensional complex received signal vector at the k^{th} subchannel be denoted by y̅ₖ. Then the complex received signal vector is given by Equation (1)
y̅ₖ= H̅ₖ x̅ₖ+ n̅ₖ (1)
where n̅ₖ denotes a Gaussian noise vector and H̅ₖ denotes a channel matrix with an entry (j, i), h̅_{ji,k} representing the path gain between an i^{th} transmit antenna and a j^{th} receive antenna.

Given the channel matrix H̅ₖ, an ML (Maximum Likelihood) solution \overline{\hat{x}}ₖ can be obtained by Equation (2)

$${{x}^{\hat{\_}}}_{k} = {[ {{x}^{\hat{\_}}}_{1 , k} {{x}^{\hat{\_}}}_{2 , k} ]}^{t} = arg {min}_{\overline{x} ∈ {Q}^{2}} {‖ {\overline{y}}_{k} - {\overline{H}}_{k} {\overline{x}}_{k} ‖}^{2} \qquad ( 2 )$$

where Q denotes a signal constellation and [•]^{t} represents the transpose of a vector or matrix.

Referring to FIG. 3, in step 310, QAM mapping is performed. Here, any other modulation scheme may be used. Before the QAM mapper, Forward Error Correction (FEC) encoding and interleaving and a Serial-to-Parallel (S/P) converting are performed.

In step 330, transmission data from the QAM mapper is predecoded. A linear pre-coder pre-codes the modulation symbols based on Channel State Information (CSI). The CSI is a rotation angle which is feedback from a receiver.

The computation of the rotation angle in the receiver is performed using Equation (9), Equation (10) and Equation (11). The transmission precoding involves encoding of the transmission signal using Equation (3) below.

$$[ \begin{matrix}1 & 0 \\ 1 & exp ( {θ}_{k} )\end{matrix} ] \qquad ( 3 )$$

If rearranged s( x̅ₖ) may be used by Real part and Imaginary part for reduction in decoding in the receiver as in Equation (4).

$$s ( {\overline{x}}_{k} ) {=}^{Δ} [ \begin{matrix}ℜ [ {\overline{x}}_{1 , k} ] + j ℜ [ {\overline{x}}_{2 , k} ] \\ 𝒯 [ {\overline{x}}_{1 , k} ] + j 𝒯 [ {\overline{x}}_{2 , k} ]\end{matrix} ] \qquad ( 4 )$$

In that case, precoding using Equation (5) is performed.

$$[ \begin{matrix}1 & 0 \\ 1 & exp ( {θ}_{k} )\end{matrix} ] s ( {\overline{x}}_{k} ) \qquad ( 5 )$$

Also Equation (1) is expressed as Equation (6)
y̅ₖ= H̅ₖ^{r}s( x̅ₖ)+ n̅ₖ (6)
where Equation (7)

$${\overline{H}}_{k}^{r} = {\overline{H}}_{k} [ \begin{matrix}1 & 0 \\ 1 & exp ( {θ}_{k} )\end{matrix} ] \qquad ( 7 )$$

corresponds to a channel matrix for s₁( x̅ₖ).

A real-valued system model is obtained, represented as Equation (8)

$$\begin{matrix}{y}_{k} = [ \begin{matrix}ℜ [ {\overline{y}}_{k} ] \\ 𝒯 [ {\overline{y}}_{k} ]\end{matrix} ] \\ = [ \begin{matrix}ℜ [ {\overline{H}}_{k}^{r} ] & - 𝔉 [ {\overline{H}}_{ k}^{ r} ] \\ 𝒯 [ {\overline{H}}_{ k}^{ r} ] & 𝒯 [ {\overline{H}}_{k}^{r} ]\end{matrix} ] [ \begin{matrix}ℜ [ {s}_{1} ( {\overline{x}}_{k} ) ] \\ 𝒯 [ {s}_{1} ( {\overline{x}}_{k} ) ]\end{matrix} ] + [ \begin{matrix}ℜ [ {\overline{n}}_{k} ] \\ 𝒯 [ {\overline{n}}_{k} ]\end{matrix} ] \\ = [ \begin{matrix}{h}_{1 , k}^{r} & {h}_{2 , k}^{r} & {h}_{3 , k}^{r} & {h}_{4 , k}^{r}\end{matrix} ] [ \begin{matrix}ℜ [ {\overline{x}}_{1 , k} ] \\ 𝒯 [ {\overline{x}}_{1 , k} ] \\ ℜ [ {\overline{x}}_{2 , k} ] \\ 𝒯 [ {\overline{x}}_{2 , k} ]\end{matrix} ] + {n}_{k} \end{matrix} \qquad ( 8 )$$

where the vector h_{i,k} denotes an i^{th} column vector of the real-valued channel matrix. The column vectors h_{1,k} and h_{2,k} are orthogonal to h_{3,k} and h_{4,k}, respectively.

In this case, the spatial multiplexing scheme is orthogonal if and only if h_{1,k}^{r} is orthogonal to h_{4,k}^{r} and h_{2,k}^{r} is orthogonal to h_{3,k}^{r}.

A rotation angle that leads to full orthogonality is computed by Equation (9)

$${θ}_{k} = {tan}^{- 1} ( \frac{{B}_{k}}{{A}_{k}} ) \pm \frac{π}{2} \qquad ( 9 )$$

where Equation (10) shows

$${A}_{k} = {\sum }_{m = 1}^{M} \vert {\overline{h}}_{m 1 , k} \vert \vert {\overline{h}}_{m 2 , k} \vert sin ( ∠ {\overline{h}}_{m 2 , k} - ∠ {\overline{h}}_{m 1 , k} ) \qquad ( 10 )$$

and Equation (11) shows

$${B}_{k} = {\sum }_{m = 1}^{M} \vert {\overline{h}}_{m 1 , k} \vert \vert {\overline{h}}_{m 2 , k} \vert cos ( ∠ {\overline{h}}_{m 2 , k} - ∠ {\overline{h}}_{m 1 , k} ) \qquad ( 11 )$$

In Equations (10) and (11), |•| and ∠ indicate the magnitude and angle of a complex number, respectively.

After the preceding is performed, Inverse Fast Fourier Transform (IFFT) processing, digital-to-analog conversion and upconversion to Radio Frequency (RF) signals are performed and than transmission through the antennas is performed in step 350.

The receiver receives the precoded data and in step 370, linear decoder 220 decodes the received data. The ML decoding estimates \overline{\hat{x}}_{1,k} and \overline{\hat{x}}_{2,k} using the following two Equations (12) and (13).

$$\begin{matrix}{{x}^{\hat{\_}}}_{1 , k} = arg {min}_{\overline{x} ∈ Q} {‖ {y}_{k} - [ \begin{matrix}{h}_{1 , k}^{r} & {h}_{2 , k}^{r}\end{matrix} ] [ \begin{matrix}ℜ [ \overline{x} ] \\ 𝒯 [ \overline{x} ]\end{matrix} ] ‖}^{2} & ( 12 ) \\ {{x}^{\hat{\_}}}_{2 , k} = arg {min}_{\overline{x} ∈ Q} {‖ {y}_{k} - [ \begin{matrix}{h}_{3 , k}^{r} & {h}_{4 , k}^{r}\end{matrix} ] [ \begin{matrix}ℜ [ \overline{x} ] \\ 𝒯 [ \overline{x} ]\end{matrix} ] ‖}^{2} & ( 13 )\end{matrix}$$

Then the process of the present invention ends.

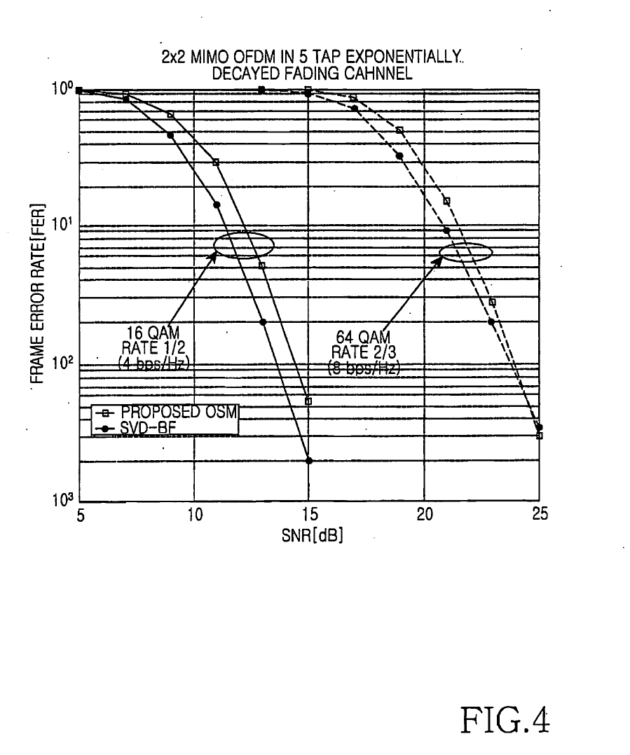

FIG. 4 is a graph comparing the conventional Singular Value Decomposition-BeamForming (SVD-BF) with the OSM of the present invention in terms of FER performance. A 5-tap multipath channel with an exponentially decaying delay profile is assumed. Also, the length of a frame is assumed to be one OFDM symbol where the total number of subchannels is 64.

For a spectral efficiency of 4 bps/Hz, the OSM scheme of the present invention performs within 1 dB of the SVD-BF at 1% FER. For a higher spectral efficiency of 8 bps/Hz, the OSM performs almost as well as the SVD-BF.

The simulation results confirm that the OSM scheme of the present invention approaches the performance of the SVD-BF or the ML technique with a reduced computation complexity from O(M_{c}²) to O(M_{c}).

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmission in a transmitter in a closed loop multiple input multiple output communication system, the method comprising the steps of:
precoding transmission symbols using a rotation angle from a receiver; and
transmitting the precoded transmission symbols over a plurality of antennas.

2. The method of claim 1, wherein the precoding step comprises encoding the transmission symbols using
$$[ \begin{matrix}1 & 0 \\ 1 & exp ( {θ}_{k} )\end{matrix} ] .$$

3. The method of claim 2, wherein the rotation angle is calculated in the receiver using
$${θ}_{k} = {tan}^{- 1} ( \frac{{B}_{k}}{{A}_{k}} ) \pm \frac{π}{2}$$
$$where$$
$${A}_{k} = {\sum }_{m = 1}^{M} \vert {\overline{h}}_{ml , k} \vert \vert {\overline{h}}_{m 2 , k} \vert sin ( ∠ {\overline{h}}_{m 2 , k} - ∠ {\overline{h}}_{ml , k} ) , \\ {B}_{k} = {\sum }_{m = 1}^{M} \vert {\overline{h}}_{ml , k} \vert \vert {\overline{h}}_{m 2 , k} \vert cos ( ∠ {\overline{h}}_{m 2 , k} - ∠ {\overline{h}}_{ml , k} ) .$$

4. The method of claim 1, wherein the communication system is an OFDM (Orthogonal Frequency Division Multiplexing) system.

5. A method of receipt in a receiver in a closed loop multiple input multiple output communication system, the method comprising the steps of:
receiving transmission symbols precoded in a transmitter using a rotation angle from the receiver over a plurality of antennas; and
linear decoding transmission symbols.

6. The method of claim 5, wherein the transmission symbols are precoded in the transmitter using
$$[ \begin{matrix}1 & 0 \\ 1 & exp ( {θ}_{k} )\end{matrix} ] .$$

7. The method of claim 6, wherein the rotation angle is calculated in the receiver using
$${θ}_{k} = {tan}^{- 1} ( \frac{{B}_{k}}{{A}_{k}} ) \pm \frac{π}{2}$$
$$where$$
$${A}_{k} = {\sum }_{m = 1}^{M} \vert {\overline{h}}_{m 1 , k} \vert \vert {\overline{h}}_{m 2 , k} \vert sin ( ∠ {\overline{h}}_{m 2 , k} - ∠ {\overline{h}}_{m 1 , k} ) , \\ {B}_{k} = {\sum }_{m = 1}^{M} \vert {\overline{h}}_{m 1 , k} \vert \vert {\overline{h}}_{m 2 , k} \vert cos ( ∠ {\overline{h}}_{m 2 , k} - ∠ {\overline{h}}_{m 1 , k} ) . fghv$$

8. The method of claim 5, wherein the communication system is an OFDM (Orthogonal Frequency Division Multiplexing) system.

9. A transmitter in a closed loop multiple input multiple output communication system, the transmitter comprising:
a precoder for precoding transmission symbols using a rotation angle from a receiver; and
a plurality of antennas over which the precoded transmission symbols are transmitted.

10. The transmitter of claim 9, wherein the precoder encodes the transmission symbols using
$$[ \begin{matrix}1 & 0 \\ 1 & exp ( {θ}_{k} )\end{matrix} ] .$$

11. The transmitter of claim 10 wherein the rotation angle is calculated in the receiver using
$${θ}_{k} = {tan}^{- 1} ( \frac{{B}_{k}}{{A}_{k}} ) \pm \frac{π}{2}$$
$$where$$
$${A}_{k} = {\sum }_{m = 1}^{M} \vert {\overline{h}}_{m 1 , k} \vert \vert {\overline{h}}_{m 2 , k} \vert sin ( ∠ {\overline{h}}_{m 2 , k} - ∠ {\overline{h}}_{m 1 , k} ) , \\ {B}_{k} = {\sum }_{m = 1}^{M} \vert {\overline{h}}_{m 1 , k} \vert \vert {\overline{h}}_{m 2 , k} \vert cos ( ∠ {\overline{h}}_{m 2 , k} - ∠ {\overline{h}}_{m 1 , k} ) .$$

12. The transmitter of claim 9, wherein the communication system is an OFDM (Orthogonal Frequency Division Multiplexing) system.

13. A receiver in a closed loop multiple input multiple output communication system, the receiver comprising:
a plurality of antennas over which transmission symbols precoded in a transmitter using a rotation angle from the receiver are received; and
a decoder for linear decoding transmission symbols.

14. The receiver of claim 13, wherein the transmission symbols are precoded in the transmitter using
$$[ \begin{matrix}1 & 0 \\ 1 & exp ( {θ}_{k} )\end{matrix} ] .$$

15. The receiver of claim 14, wherein the rotation angle is calculated in the receiver using
$${θ}_{k} = {tan}^{- 1} ( \frac{{B}_{k}}{{A}_{k}} ) \pm \frac{π}{2}$$
$$where$$
$${A}_{k} = {\sum }_{m = 1}^{M} \vert {\overline{h}}_{m 1 , k} \vert \vert {\overline{h}}_{m 2 , k} \vert sin ( ∠ {\overline{h}}_{m 2 , k} - ∠ {\overline{h}}_{m 1 , k} ) , \\ {B}_{k} = {\sum }_{m = 1}^{M} \vert {\overline{h}}_{m 1 , k} \vert \vert {\overline{h}}_{m 2 , k} \vert cos ( ∠ {\overline{h}}_{m 2 , k} - ∠ {\overline{h}}_{m 1 , k} ) .$$

16. The receiver of claim 13, wherein the communication system is an OFDM (Orthogonal Frequency Division Multiplexing) system.
